(19) United States
(12) Patent Application Publication
(10) Pub. No.: US 2004/0244021 A1
(43) Pub. Date: Dec. 2, 2004

(54) Anti-vibration tray support structure

(75) Inventor: Ko-Chun Wang, Hsinchu (TW)

Correspondence Address: WILMER CUTLER PICKERING HALE AND DORR LLP, THE WILLARD OFFICE BUILDING, 1455 PENNSYLVANIA AVE, NW, WASHINGTON, DC, 20004, US

(73) Assignee: Actima Technology Corporation, Hsinchu (TW)

(21) Appl. No.: 10/650,724

(22) Filed: Aug. 29, 2003

(30) Foreign Application Priority Data
May 28, 2003 (TW) 092114462

(51) Int. Cl. G11B 17/03; G11B 17/04; G11B 33/02

(52) U.S. Cl. 720/611

(57) ABSTRACT

An anti-vibration tray support structure installed in an optical disc player is employed to minimize vibration while loading and unloading the tray. The anti-vibration tray support structure has a tray with two slots in the bottom side thereof, two rails employed to fit and support two slots, and an elastic holder contacting a right or left side of the tray to provide an anti-vibration force.

### BACKGROUND OF THE INVENTION

1. Field of Invention

The present invention relates to anti-vibration tray support structure. More particularly, the present invention relates to anti-vibration tray support structure in an optical disc player.

2. Description of Related Art

The optical disc player is one of the most popular electronic apparatuses. It can be installed in a personal computer, such as a CD-ROM (compact-disc read-only-memory) or in a several kinds of information appliances, such as a VCD (video-compact-disc) player or DVD (digital-versatile-disc) player. The optical disc player is employed to read out the data in various kinds of optical storage media.

In order to access various kinds of optical storage media quickly, optical disc player manufacturers and chipset suppliers thereof are interested in how shorten access time for reading out the data can be shortened. On the other hand, all other performance reliabilities, such as mechanical reliability, are another point of interest.

Before a spindle motor carries an optical disc and begins to rotate, a tray is employed to support the optical disc temporarily. The tray further also provides optical disc loading and unloading functions for users to put in and take out the optical disc. Loading and unloading of the tray are conducted by a motor driving the tray on a rail. When the tray moves out to an end of the rail, a holder prevents the tray from moving. However, the moving tray and the unstopped driving cause the tray to bump into the holder. The drawback is a vibration of the tray in the horizontal direction when bumping into the holder. For the forgoing reasons, there is a need for overcoming the vibration issue during the process of loading and unloading the tray.

### SUMMARY OF THE INVENTION

It is therefore an objective of the present invention to provide anti-vibration tray support structure in optical disc player so as to minimize tray loading and unloading vibration.

In accordance with the foregoing and other objectives of the present invention, an anti-vibration tray support structure installed in an optical disc player is employed to minimize vibration while loading and unloading the tray. The anti-vibration tray support structure includes a tray with two slots in the bottom side, two rails employed to fit and support the two slots, and an elastic holder contacting a right or left side of the tray to provide an anti-vibration force.

According to one preferred embodiment of this invention, the rail, the elastic holder and the outer housing of the optical player are integrated together by plastic casting. Moreover, the elastic holder can also be a metal elastic apparatus.

In general, the anti-vibration tray support structure can reduce vibration in the horizontal direction when the holder bumps into an end of the tray's slot. In addition, the elastic holder made by plastic casting is cost-effective.

It is to be understood that both the foregoing general description and the following detailed description are examples, and are intended to provide further explanation of the Invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A illustrates a top view of an optical disc player according to one preferred embodiment of this invention;

FIG. 1B illustrates an enlarged top view of an anti-vibration tray support structure in FIG. 1A according to one preferred embodiment of this invention;

FIG. 2A illustrates a perspective view of an optical disc player's structure according to one preferred embodiment of this invention;

FIG. 2B illustrates an enlarged partial top view of an anti-vibration tray support structure in FIG. 2A according to one preferred embodiment of this invention; and

FIG. 3 illustrates a cross-sectional view of anti-vibration tray support structure according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention is employed to deal with a vibration issue while loading and unloading a tray of an optical disc player. In one preferred embodiment of present invention, an anti-vibration tray support structure is provided to reduce vibration in the horizontal direction when the holder bumps into an end of the tray's slot. The following will give a preferred embodiment of the present invention.

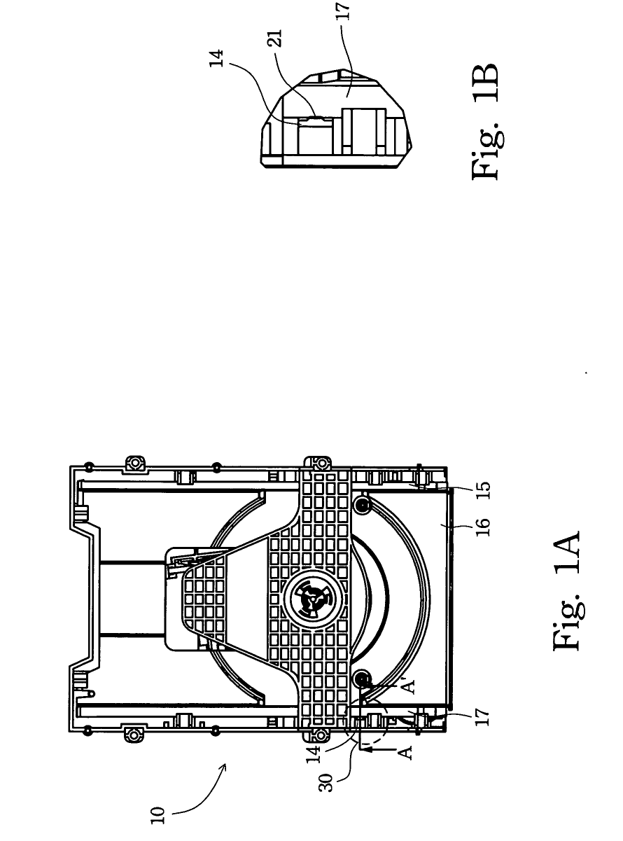

FIG. 1A illustrates a top view of an optical disc player according to one preferred embodiment of this invention. An optical disc player 10 includes a tray 16 for loading and unloading optical storage media. A left side 17 and a right side 15 of the tray 16 respectively have slots in the bottom side thereof (not illustrated in drawings). Rails fit and support the slots so as to provide a low-friction moving path for the tray 16. A motor is employed to drive the tray 16 to move in and to move out. An elastic holder 14 is provided to contact the left side 17 of the tray 16. The force offered by the elastic holder 14 pushes the slots against the rails so as to avoid vibration.

FIG. 1B illustrates an enlarged top view of an anti-vibration tray support structure according to one preferred embodiment of this invention. FIG. 1B is an enlarged view of a dashed circle 30 in FIG. 1A. Specially, a contact area 21 between the elastic holder 14 and the left side 17 of the tray 16 is minimized to reduce the friction therebetween. However, the area reduction does not decrease the pushing force provided by the elastic holder 14 against the left side 17 of the tray 16.

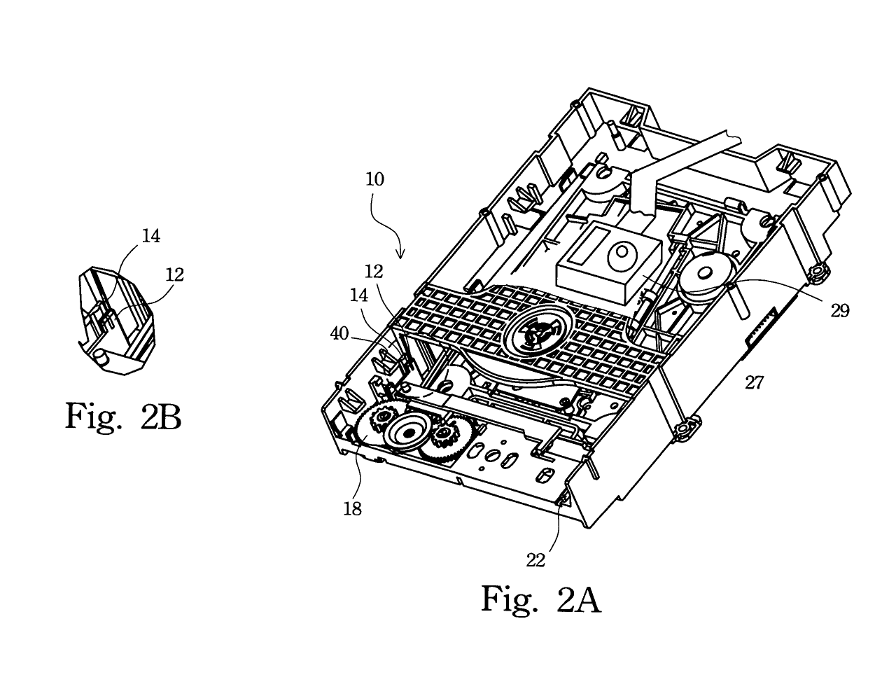

FIG. 2A illustrates a perspective view of an optical disc player's structure according to one preferred embodiment of this invention. This figure illustrates the optical disc player removing the tray. The optical disc player includes several important components, such as a laser pickup head 29 employed to read an optical disc, a spindle motor 27 employed to rotate an optical disc, and an assembly 18 of a driving motor and gears. Moreover, the anti-vibration tray support structure includes an elastic holder 14, a rail 12 and a rail 22.

FIG. 2B illustrates an enlarged partial top view of an anti-vibration tray support structure according to one preferred embodiment of this invention. FIG. 2B is an enlarged view of a dashed circle 40 in FIG. 2A. FIG. 2B clearly illustrates the structure of the rail 12 and the elastic holder 14.

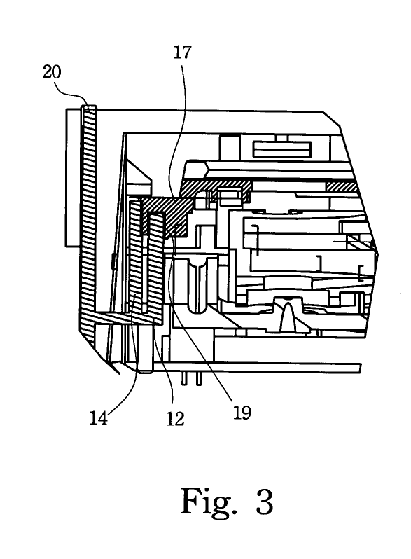

FIG. 3 illustrates a cross-sectional view of anti-vibration tray support structure along cross-section line A-A′ in FIG. 1 according to one preferred embodiment of this invention. FIG. 3 illustrates a left side 17 of the tray, a rail 19, a rail 12, an elastic holder 14 and an outer housing 20. In one preferred embodiment of this invention, the elastic holder 14 is made by plastic casting. In order to reduce manufacturing costs, the rail 12, the elastic holder 14 and the outer housing 20 are integrated into one single structure. In other words, a predetermined plastic casting mold is employed to manufacture the rail 12, the elastic holder 14 and the outer housing 20 together. Thus, adding the elastic holder 14 is cost-effective. Alternatively, the elastic holder 14 can be a metal elastic apparatus.

According to the preferred embodiments of this invention, the anti-vibration tray support structure can reduce vibration in the horizontal direction when the holder bumps into an end of the tray's slot. in addition, the elastic holder made by plastic casting is cost-effective.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A anti-vibration tray support structure in an optical disc player, said anti-vibration tray support structure comprising:
a tray including two slots in a bottom side thereof;
two rails employed to support said two slots, respectively; and
an elastic holder installed beside one of said two rails, said elastic holder contacting one side of said tray to provide a proper force against vibration.

2. The anti-vibration tray support structure of claim 1, wherein said two rails are made by plastic casting.

3. The anti-vibration tray support structure of claim 1, wherein said elastic holder is made by plastic casting.

4. The anti-vibration tray support structure of claim 1, wherein said elastic holder is a metal elastic apparatus.

5. A anti-vibration tray support structure in an optical disc player, said anti-vibration tray support structure comprising:
a tray including two slots in a bottom side thereof;
two rails employed to support said two slots, respectively; and
at least one elastic holder installed beside one of said two rails, said elastic holder contacting one side of said tray to provide a proper force against vibration.

6. The anti-vibration tray support structure of claim 5, wherein said two rails are made by plastic casting.

7. The anti-vibration tray support structure of claim 5, wherein said elastic holder is made by plastic casting.

8. The anti-vibration tray support structure of claim 5, wherein said elastic holder is a metal elastic apparatus.

9. An optical disc player with a tray anti-vibration function comprising:
a tray including two slots in a bottom side thereof, said tray supporting an optical disc;
two rails employed to support said two slots, respectively;
at least one elastic holder installed beside one of said two rails, said elastic holder contacting one side of said tray to provide a proper force against vibration;
a laser pickup head; and
a spindle motor employed to rotate said optical disc so as to allow said laser pickup head to read said optical disc.

10. The optical disc player of claim 9, wherein said two rails are made by plastic casting.

11. The optical disc player of claim 9, wherein said elastic holder is made by plastic casting.

12. The optical disc player of claim 9, wherein said elastic holder is a metal elastic apparatus.
